(19) United States
(12) Patent Application Publication
(10) Pub. No.: US 2005/0231706 A1
(43) Pub. Date: Oct. 20, 2005

(54) Feedforward control with reduced learning time for lithographic system to improve throughput and accuracy

(75) Inventors: Pai-Hsueh Yang, Palo Alto, CA (US); Hideyuki Hashimoto, Saitama (JP); Bausan Yuan, San Jose, CA (US); Atsushi Yamaguchi, Kanagawa (JP); Susumu Makinouchi, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Nikon Corporation, Tokyo (JP)

(21) Appl. No.: 10/825,022

(22) Filed: Apr. 14, 2004

(51) Int. Cl. G03B 27/58

(52) U.S. Cl. 355/72; 355/75; 355/53

(57) ABSTRACT

Embodiments of the present invention are directed to a control system and method for controlling the trajectory and alignment of one or more stages by incorporating a grouping method in the control methodology. In one embodiment, a method of controlling movement of one or more stages of a precision assembly to process a substrate having a plurality of process regions comprises dividing the substrate into blocks according to one or more preset criteria, each block of the substrate including one or more process regions; generating learning data for one or more representative process regions for each block of the substrate; and using the generated learning data of the one or more representative process regions of each block to control movement of the one or more stages to process the block of one or more process regions of the substrate.

### CROSS-REFERENCES TO RELATED APPLICATIONS

This application relates to U.S. Provisional Patent Application No. 60/424,506, filed Nov. 6, 2002, the entire disclosure of which is incorporated herein by reference.

### BACKGROUND OF THE INVENTION

The present invention relates generally to a control system and method for controlling the trajectory and alignment of one or more stages in a semiconductor wafer exposure system and, more particularly, to a grouping method incorporated in the iterative learning control methodology.

An exposure apparatus is one type of precision assembly that is commonly used to transfer images from a reticle onto a semiconductor wafer during semiconductor processing. A typical exposure apparatus includes an illumination source, a reticle stage assembly that retains a reticle, an optical assembly, a wafer stage assembly that retains a semiconductor wafer, a measurement system, and a control system.

In one embodiment, the wafer stage assembly includes a wafer stage that retains the wafer, and a wafer mover assembly that precisely positions the wafer stage and the wafer. The reticle stage assembly includes a reticle stage that retains the reticle, and a reticle mover assembly that positions the reticle stage and the reticle. The control system independently directs current to the wafer mover assembly and the reticle mover assembly to generate one or more forces that cause the movement along a trajectory of the wafer stage and the reticle stage, respectively.

The size of the images and features within the images transferred onto the wafer from the reticle are extremely small. Accordingly, the precise positioning of the wafer and the reticle relative to the optical assembly is critical to the manufacture of high density, semiconductor wafers. In some embodiments, numerous identical integrated circuits are derived from each semiconductor wafer. Therefore, during this manufacturing process, the wafer stage and/or the reticle stage can be cyclically and repetitiously moved to emulate an intended trajectory. Each intended trajectory that is similar to a previous intended trajectory of one of the stages is also referred to herein as an “iteration” or a “cycle.”

Unfortunately, during the movement of the stages, a following error of the wafer stage and/or the reticle stage can occur. The following error is defined by the difference between the intended trajectory of the wafer stage and/or the reticle stage and an actual trajectory of the stage at a specified time. For example, the following error can occur due to a lack of complete rigidity in the components of the exposure apparatus, which can result in a slight time delay between current being directed to the mover assembly and subsequent movement of the stage.

Additionally, alignment errors can occur even if the stages are properly positioned relative to each other. For example, periodic vibration disturbances of various mechanical structures of the exposure apparatus may occur. More specifically, oscillation or resonance of the optical assembly and/or other supporting structures can inhibit relative alignment between the stages and the optical assembly. As a result of the following errors and/or the vibration disturbances, precision in the manufacture of the semiconductor wafers can be compromised, potentially leading to production of a lesser quality semiconductor wafer.

Attempts to decrease the following errors include the use of a feedback control loop. In these types of systems, during movement of one of the stages, the measurement system periodically provides information regarding the current position of the stage. This information is utilized by the control system to adjust the level of current to the mover assembly in an attempt to achieve the intended trajectory. Unfortunately, this method is not entirely satisfactory and the control system does not always precisely move each stage along its intended trajectory.

In light of the above, there is a need for a control system that can improve the accuracy in the positioning of the stage. Further, there is a need for a control system that can accurately adjust the positioning of the wafer stage and/or the reticle stage to produce higher quality semiconductor wafers.

### BRIEF SUMMARY OF THE INVENTION

Embodiments of the present invention are directed to a control system and method for controlling the trajectory and alignment of one or more stages by incorporating a grouping method in the control methodology. A substrate has a plurality of process regions or shot regions to be processed by, for example, scanning. The substrate is divided into blocks or groups of shot regions. Learning data is obtained from representative shot regions in each block and used to control the stages to process the entire block of shot regions. The control scheme employing the grouping method is more accurate than previous control schemes that employ control data obtained for one shot region to control the process of the entire substrate, and is more efficient than previous control schemes that require control data to be obtained for all the shot regions.

In accordance with an aspect of the present invention, a method of controlling movement of one or more stages of a precision assembly to process a substrate having a plurality of process regions comprises dividing the substrate into groups or blocks according to one or more preset criteria, each block of the substrate including one or more process regions; generating learning data for one or more representative process regions for each block of the substrate; and using the generated learning data of the one or more representative process regions of each block to control movement of the one or more stages to process the block of one or more process regions of the substrate.

In some embodiments, the blocks or groups comprise at least one center block in a center region of the substrate and at least one edge block in an edge region of the substrate. Each center block is larger in area than each edge block. The blocks may comprise a block having a row of process regions along a stepping direction and transverse to a scanning direction for a step-and-scan processing of the substrate. The blocks may comprise a block having a plurality of process regions selected from a row of process regions along a stepping direction and transverse to a scanning direction for a step-and-scan processing of the substrate. Dividing the substrate into blocks may comprise selecting process regions having substantially the same force effects and grouping the selected process regions into a block. Dividing the substrate into blocks may comprise selecting process regions having substantially the same stage position errors and grouping the selected process regions into a block. Dividing the substrate into blocks may comprise selecting process regions having substantially the same center of gravity calibration errors and grouping the selected process regions into a block. The blocks or groups may comprise a block having process regions which are spaced from each other by other process regions.

In specific embodiments, generating learning data may comprise performing an iterative learning control process on iterative learning control input data which is selected from the group consisting of a following error of the one or more stages and a force command of the one or more stages. Generating learning data may comprise generating a force feedforward to be applied to the one or more stages. Generating learning data may comprise generating a position feedforward control to fine-adjust a following error of the one or more stages which is processed by a feedback control to control movement of the one or more stages. The method may further comprise performing at least one of interpolating or extrapolating the learning data generated for the representative process regions to generate additional learning data for other process regions; and using the additional learning data to control movement of the one or more stages to process the other process regions of the substrate.

In accordance with another aspect of the invention, a system of controlling movement of one or more stages of a precision assembly to process a substrate having a plurality of process regions comprises a position compensation module configured to generate learning data for one or more representative process regions for each block of a plurality of blocks of a substrate, each block including one or more process regions; and a stage control module configured to use the generated learning data of the one or more representative process regions of each block to control movement of the one or more stages to process the block of one or more process regions of the substrate.

Another aspect of the present invention is directed to a system for controlling movement of one or more stages of a precision assembly to process a substrate having a plurality of process regions, and the system has one or more memories. The one or more memories comprise code for generating learning data for one or more representative process regions for each block of a plurality of blocks of a substrate, each block including one or more process regions; and code for using the generated learning data of the one or more representative process regions of each block to control movement of the one or more stages to process the block of one or more process regions of the substrate.

### BRIEF DESCRIPTION OF THE DRAWINGS

FIG. 1 is a schematic view of an exposure apparatus having features of the present invention.

FIG. 2A is a perspective view of a stage assembly having features of the present invention.

FIG. 2B is a perspective view of another stage assembly having features of the present invention.

FIG. 3A is a graph including curves illustrating an intended trajectory and an actual trajectory as a function of time during movement of a stage over a plurality of iterations.

FIG. 3B is a graph illustrating a following error of the stage in FIG. 3A as a function of time.

FIG. 4 is a graph illustrating an actual trajectory as a function of time during movement of the stage over a plurality of iterations.

FIG. 5A is a block diagram of a control system for controlling a stage assembly according to an embodiment of the invention.

FIG. 5B is a block diagram of a control system for controlling a stage assembly according to another embodiment of the invention.

FIG. 6 is a schematic diagram of a wafer illustrating a grouping method according to an embodiment of the invention.

FIG. 7 is a plot illustrating the interpolating/extrapolating scheme used in the grouping method according to an embodiment of the invention.

FIG. 8 is a schematic diagram of a wafer illustrating a grouping method according to another embodiment of the invention.

FIG. 9 is a simplified schematic diagram illustrating a stage apparatus for centre of gravity error compensation.

FIG. 10 is a plot illustrating the force ripple of a stage apparatus.

FIG. 11 is a flow diagram illustrating a learning control method incorporating a grouping scheme according to an embodiment of the present invention.

FIG. 12 is a flow diagram illustrating an iterative learning control method which may be implemented according to an embodiment of the invention.

FIG. 14 is a diagrammatic representation of a photolithography apparatus which includes a scanning stage with a dual force mode fine stage in accordance with another embodiment of the present invention.

FIG. 15 is a process flow diagram which illustrates the steps associated with fabricating a semiconductor device in accordance with an embodiment of the present invention.

FIG. 15 is a process flow diagram which illustrates the steps associated with processing a wafer, i.e., step 1304 of FIG. 14, in accordance with an embodiment of the present invention.

### DETAILED DESCRIPTION OF THE INVENTION

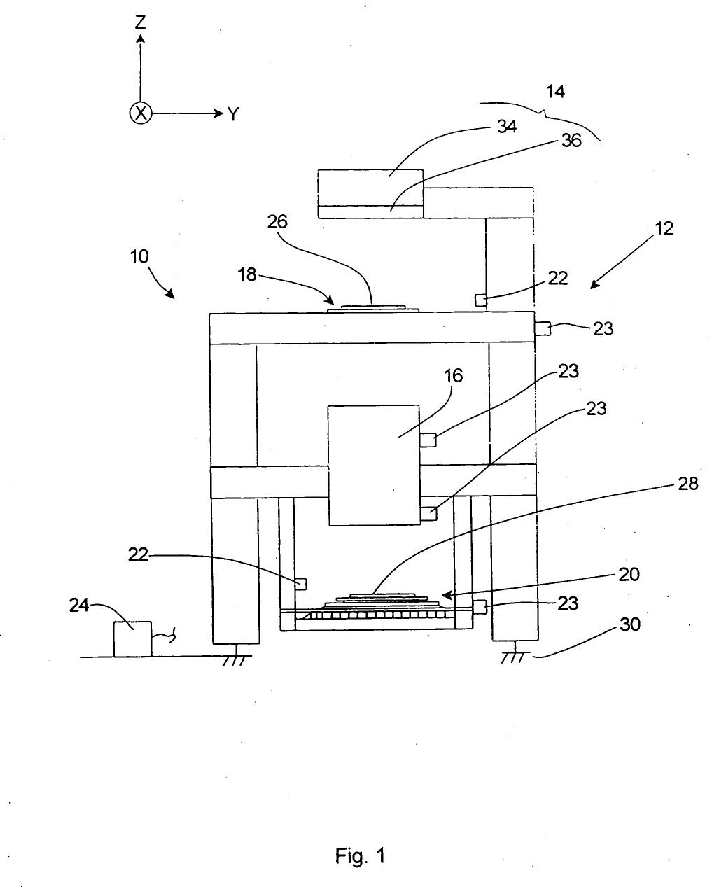

FIG. 1 is a schematic illustration of a precision assembly, namely, an exposure apparatus 10. The exposure apparatus 10 includes an apparatus frame 12, an illumination system 14 (irradiation apparatus), an assembly 16 such as an optical assembly, a reticle stage assembly 18, a wafer stage assembly 20, a measurement system 22, one or more sensor 23, and a control system 24 having features of the present invention. The specific design of the components of the exposure apparatus 10 may be varied to suit the design requirements of the particular application.

As provided herein, the control system 24 utilizes a position compensation system or module that improves the accuracy in the control and relative positioning of at least one of the stage assemblies 18, 20. An orientation system used herein includes an X axis, a Y axis which is orthogonal to the X axis, and a Z axis which is orthogonal to the X and Y axes. The X, Y, and Z axes are also referred to as first, second, and third axes. The exposure apparatus 10 is particularly useful as a lithographic device that transfers a pattern of an integrated circuit from a reticle 26 onto a semiconductor wafer 28. The exposure apparatus 10 is mounted to a mounting base 30, such as the ground, a base, a floor, or some other supporting structure.

There are different types of lithographic devices. For example, the exposure apparatus 10 may be used as a scanning type photolithography system that exposes the pattern from the reticle 26 onto the wafer 28 with the reticle 26 and the wafer 28 moving synchronously. In a scanning type lithographic device, the reticle 26 is moved perpendicularly to an optical axis of the assembly 16 by the reticle stage assembly 18 and the wafer 28 is moved perpendicularly to the optical axis of the assembly 16 by the wafer stage assembly 20. Scanning of the reticle 26 and the wafer 28 occurs while the reticle 26 and the wafer 28 are moving synchronously.

The apparatus frame 12 is rigid and supports the components of the exposure apparatus 10. As seen in FIG. 1, the apparatus frame 12 supports the assembly 16 and the illumination system 14 above the mounting base 30. The illumination system 14 includes an illumination source 34 and an illumination optical assembly 36. The illumination source 34 emits a beam (irradiation) of light energy. The illumination optical assembly 36 guides the beam of light energy from the illumination source 34 to the assembly 16. The beam illuminates selectively different portions of the reticle 26 and exposes the wafer 28. The assembly 16 is typically an optical assembly that projects and/or focuses the light passing through the reticle 26 to the wafer 28. Depending upon the design of the exposure apparatus 10, the assembly 16 can magnify or reduce the image illuminated on the reticle 26. The assembly 16 need not be limited to a reduction system, but may be a 1x or a magnification system.

The reticle stage assembly 18 holds and positions the reticle 26 relative to the assembly 16 and the wafer 28. Somewhat similarly, the wafer stage assembly 20 holds and positions the wafer 28 with respect to the projected image of the illuminated portions of the reticle 26. Movement of the stages generates reaction forces that can affect performance of the photolithography system. Typically, numerous integrated circuits are derived from a single wafer 28. Therefore, the scanning process may involve a substantial number of repetitive, identical, or substantially similar movements of portions of the reticle stage assembly 18 and/or the wafer stage assembly 20. Each such repetitive movement is also referred to herein as an iteration, iterative movement, or iterative cycle.

The measurement system 22 monitors movement of the reticle 26 and the wafer 28 relative to the assembly 16 or some other reference. With this information, the control system 24 can control the reticle stage assembly 18 to precisely position the reticle 26 and the wafer stage assembly 20 to precisely position the wafer 28 relative to the assembly 16. For example, the measurement system 22 may utilize multiple laser interferometers, encoders, and/or other measuring devices. Additionally, one or more sensors 23 can monitor and/or receive information regarding one or more components of the exposure apparatus 10. Information from the sensors 23 can be provided to the control system 24 for processing. The control system 24 also receives information from the measurement system and other systems, and controls the stage mover assemblies 18, 20 to precisely and synchronously position the reticle 26 and the wafer 28 relative to the assembly 16 or some other reference. The control system 24 includes one or more processors and circuits for performing the functions described herein.

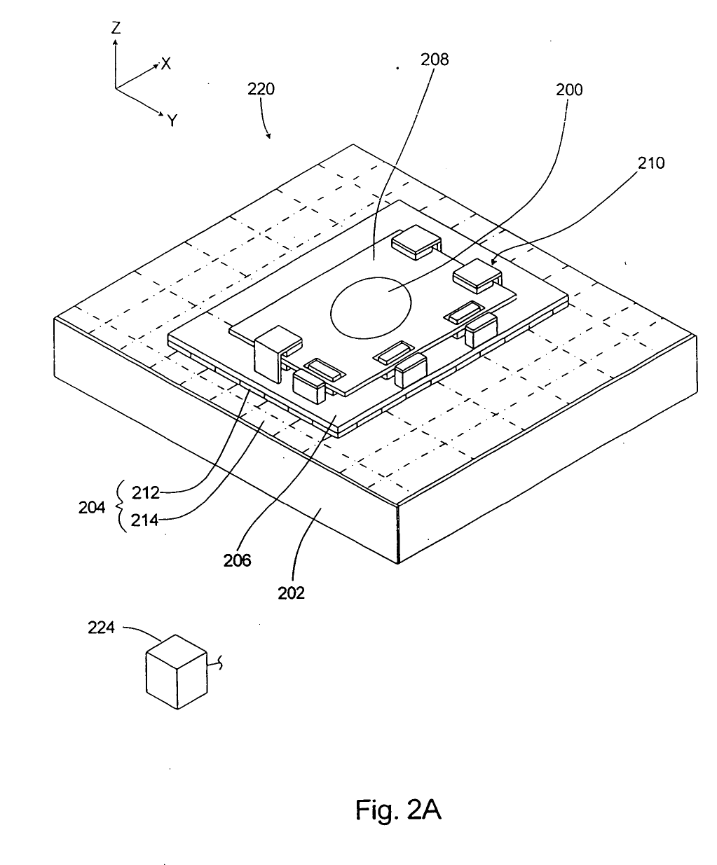

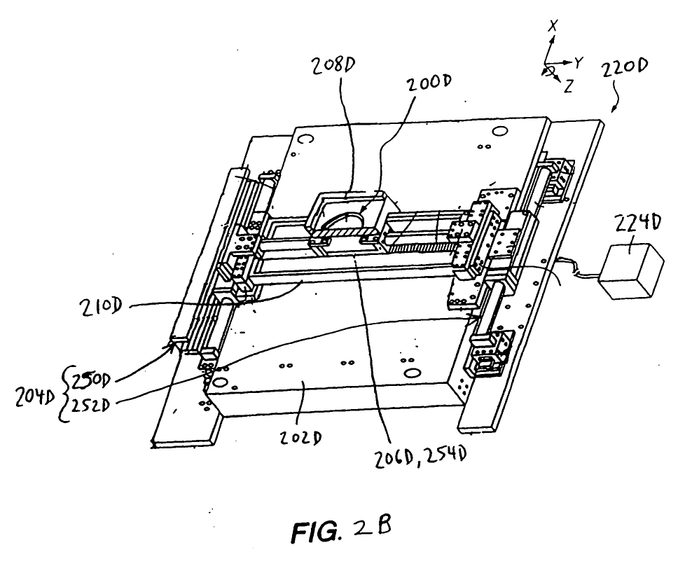

FIG. 2A shows a stage assembly 220 that is used to position a device 200, and a control system 224. The stage assembly 220 may be used as the reticle stage assembly 18 to position the reticle 26 of FIG. 1, or may also be used as the wafer stage assembly 20 to position the wafer 28 of FIG. 1. The stage assembly 220 includes a stage base 202, a coarse stage mover assembly 204, a coarse stage 206, a fine stage 208, and a fine stage mover assembly 210. The coarse stage mover assembly 204 moves the coarse stage 206 relative to the stage base 202 along the X axis, along the Y axis, and about the Z axis (collectively “the planar degrees of freedom”). The coarse stage mover assembly 204 includes a first mover component 212 that is secured to and moves with the coarse stage 206 and a second mover component 214 (illustrated in phantom) that is secured to the stage base 202. The first mover component 212 includes a magnet array, and the second mover component 214 includes a conductor array. The first mover component 212 can be maintained above the second mover component 214 with vacuum pre-load type air bearings or the like. The control system 224 directs current to one or more of the conductors in the conductor array. The electrical current through the conductors causes the conductors to interact with the magnetic field of the magnet array. This generates a force between the magnet array and the conductor array that can be used to control, move, and position the first mover component 212 and the coarse stage 206 relative to the second mover component 214 and the stage base 202. The control system 224 adjusts and controls the current level for each conductor to achieve the desired resultant forces, and to position the coarse stage 206 relative to the stage base 202.

The fine stage 208 includes a device holder that retains the device 200. The fine stage mover assembly 210 moves and adjusts the position of the fine stage 208 relative to the coarse stage 206. The fine stage mover assembly 210 typically moves the fine stage 208 in six degrees of freedom, but may provide only three degrees of freedom of movement in some cases.

FIG. 2B shows another stage assembly 220D that is used to position a device 200D, and a control system 224D having features of the present invention. The stage assembly 220D includes a stage base 202D, an X mover assembly 204D, a Y mover assembly 206D, a stage 208D, and a guide assembly 210D. The X mover assembly 204D includes a first X mover 250D and a second X mover 252D which move the guide assembly 210D and the stage 208D along the X axis. The Y mover assembly 206D includes a Y mover 254D that moves the stage 208D along the Y axis.

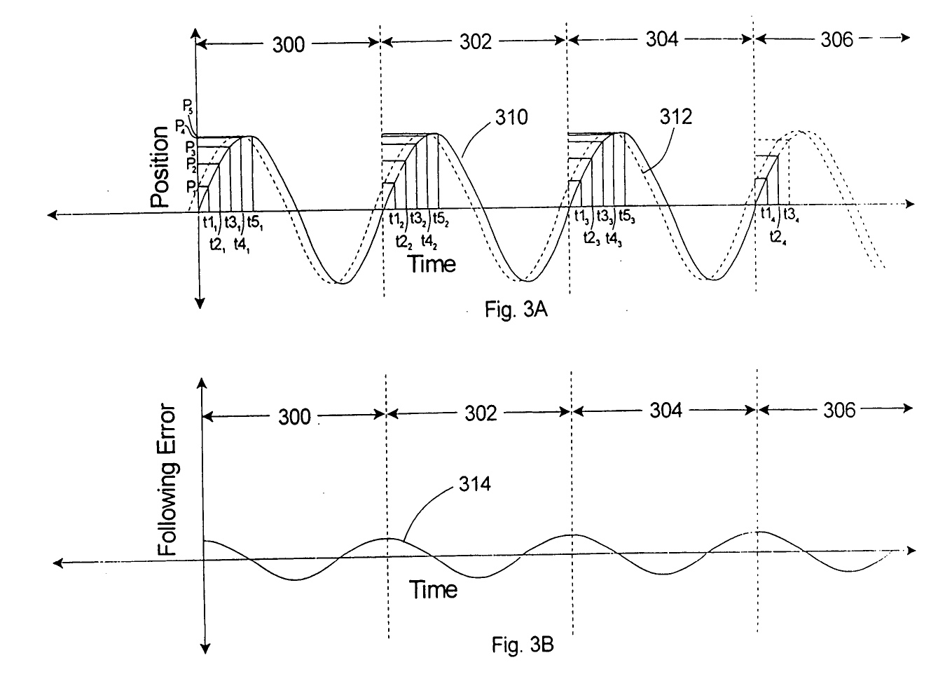

FIG. 3A is a graph illustrating an overview of an actual and an intended simplified back-and-forth type of iterative movement of a stage, such as the fine stage 208 shown in FIG. 2A or the stage 208D of FIG. 2B, along a single axis as a function of time over the course of a plurality of substantially similar iterations of the stage. The curve 310 (shown as a solid line) illustrates the actual trajectory of the stage, and the curve 312 (shown as a dashed line) illustrates the intended trajectory of the stage. The spacing between the curves 310, 312 has been exaggerated for illustrative purposes. Each iteration can include the intended trajectory of the stage and the actual trajectory of the stage that emulates the intended trajectory. Two or more intended trajectories can be considered iterations under various circumstances, as discussed in U.S. Provisional Application No. 60/424,506.

For illustrative purposes, FIG. 3A includes a first iteration 300, a second iteration 302, a third iteration 304, and a portion of a fourth iteration 306, which is also referred to herein as the “current iteration.” The actual trajectory 310 of an iteration may be substantially similar to the actual trajectory 310 of the previous iteration, although the identical trajectories 310 for each iteration 300-306 may not necessarily be identical. For example, during the first iteration 300 at times t1₁, t2₁, t3₁, t4₁, and t5₁, the measured position of the stage is located at positions P₁, P₂, P₃, P₄, and P₅ (hereinafter the “actual position”) respectively. Somewhat similarly, the second iteration 302 includes times t1₂ through t5₂, the third iteration 304 includes times t1₃ through t5₃, and the fourth iteration 306 includes t1₄ through t3₄. Each of the items t1₂ through t5₂ of the second iteration 302 and times t1₃ through t5₃ of the third iteration 304 has an actual position that is similar, though not necessarily identical, to a corresponding actual position P₁ through P₅, respectively. Each of the times t1₄ through t3₄ of the fourth iteration 306 has an actual position point that is similar, though not necessarily identical, to a corresponding actual position P₁ through P₃, respectively. It is recognized that the second and third iterations 302, 304, although similar in movement to previous first and second iterations 300, 302, respectively, can vary somewhat as a result of the additional information collected and utilized by the control system 24 and subsequent adjustments that the control system 24 makes in directing current to the one or more mover assemblies to cause forces that more accurately move the stage.

During learning, desired trajectories of various speeds and position lengths are applied and the respective learning results are saved individually. These learning results then can be interpolated for the applications of any speed and motion length later. It is noted that the above merely describes an example, and the “similarity” between the actual trajectory of an iteration and the actual trajectory of the previous iteration may be more general. After the learning is done, for instance, the velocity and shot-size may be changed.

The control system 24 provided herein can include one or more control modes. In one embodiment, the control system 24 includes a first control mode and a second control mode. As an overview, the first control mode includes the processing of input data such as positioning data received by the control system 24 during a single iteration to control future movement of the stage also during the first iteration. The second control mode includes the processing of input data received by the control system during at least one iteration (e.g., the first iteration 300 and the second iteration 302) to control future movement of the stage during the second iteration 302 and/or third iteration 304, as one example. In an iterative learning control (ILC) algorithm, the input data is referred to as learning algorithm input data. In general, the learning algorithm input data may include following error data or force command data. Force command refers to the force to be applied to the mechanical system to move a stage. The following error data can be derived from positioning data. The positioning data may include various types of information to be received and/or processed by the control system, such as time dependent positioning data or position dependent positioning data.

The first control mode can be described with reference to the first iteration 300 in FIG. 3A. In a simplified example, to determine the amount of current that the control system 24 needs to direct to the mover assemblies to position the stage in accordance with the intended trajectory 310 of the stage at time t4₁, time-dependent positioning data is provided to the control system 24 from one or more of the previous times t1₁ through t3₁. This positioning data is analyzed by the control system 24 along with the intended trajectory 310 to determine the force that is required to move the stage at time t4₁. With this positioning data, the control system 24 applies an appropriate control law to determine the amount of current to direct to the mover assemblies to obtain the required force distribution for moving the stage to the extent necessary for proper positioning of the stage. The number of data points t1₁ through t3₁ used in this analysis can vary. The first control mode can be used for movement of the stage with one or more degrees of freedom.

The second control mode can selectively be used by the control system 24 depending upon the requirements of the stage assembly. The second control mode includes the features of the first control mode described above, as well as the processing of learning algorithm input data received by the control system 24 during one or more previous iterations to control movement of the stage during the fourth iteration 302. In contrast with the first control mode, the learning algorithm input data from a previous iteration, but at a later point in time during the pervious iteration, can be used in controlling movement of the stage during the current iteration. For example, to determine the level of current to direct to the mover assembly at time t3₄, learning algorithm input data from times t4₁ and t5₁ from the first iteration 300, times t4₂ and t5₂ from the second iteration 302, and/or times t4₃ and t5₃ from the third iteration 304 can be used. This learning algorithm input data can be used in conjunction with or in the alternative to learning algorithm input data from times t1₁ through t3₁ of the first iteration 300, times t1₂ through t3₂ of the second iteration 302, and/or times t1₃ through t3₃ of the third iteration 304, or any portions thereof. With this design, a greater amount of learning algorithm input data factors into controlling the stage with the control system 24. Moreover, the second control mode can also utilize learning algorithm input data from the current iteration (e.g., the fourth iteration 306) to control the actual trajectory 310 during the current iteration 306. Thus, the second control mode of the control system 24 can take into account both intra-iteration and inter-iteration trends in the learning algorithm input data. Consequently, with each successive iteration, the positioning error is decreased.

FIG. 3B shows an example of the following error 314 of the stage over the first, second, third, and fourth iterations 300-306 based on the intended trajectory 312 and the actual trajectory 310 illustrated in FIG. 3A.

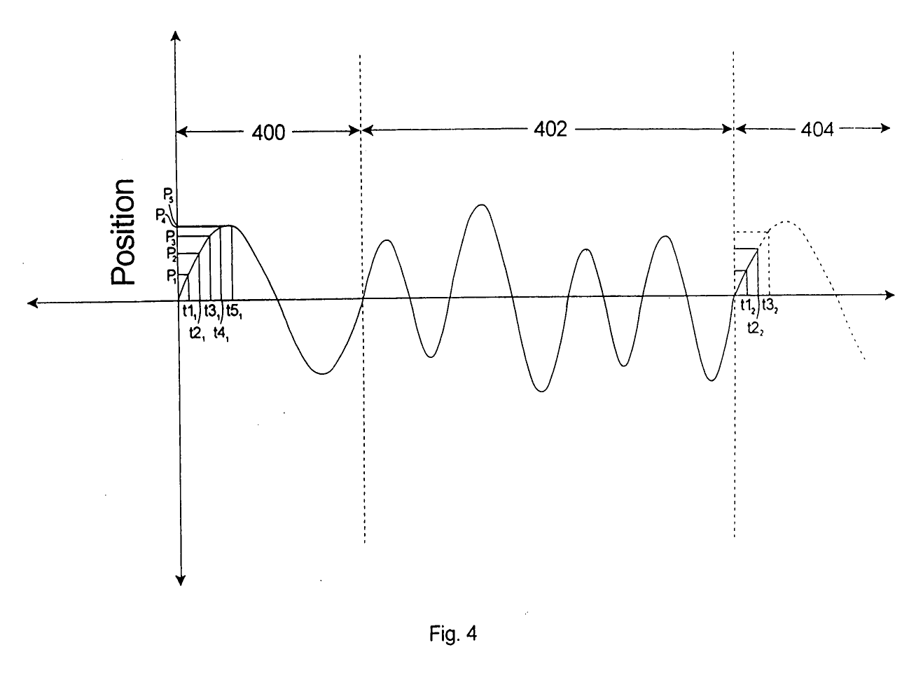

FIG. 4 is a graph that illustrates two simplified back-and-forth iterative movements of the stage as shown in FIG. 2A, for example, which include a first iteration 400 and a second iteration 404, separated in time by a period of other non-iterative movements 402 of the stage. In this embodiment, the second control mode of the control system provided herein does not necessarily require the iterations to be consecutive. For example, the control system can store learning algorithm input data from the first iteration 400 to be used for positioning the stage during the second iteration 404. The control system can identify when an intended movement or trajectory of the stage is similar to a previous movement or trajectory of the stage. Once this occurs, the control system can draw from the previously stored learning algorithm input data to adjust the amount of the current to direct to the mover assembly for more accurately positioning the stage in accordance with the intended trajectory of the stage.

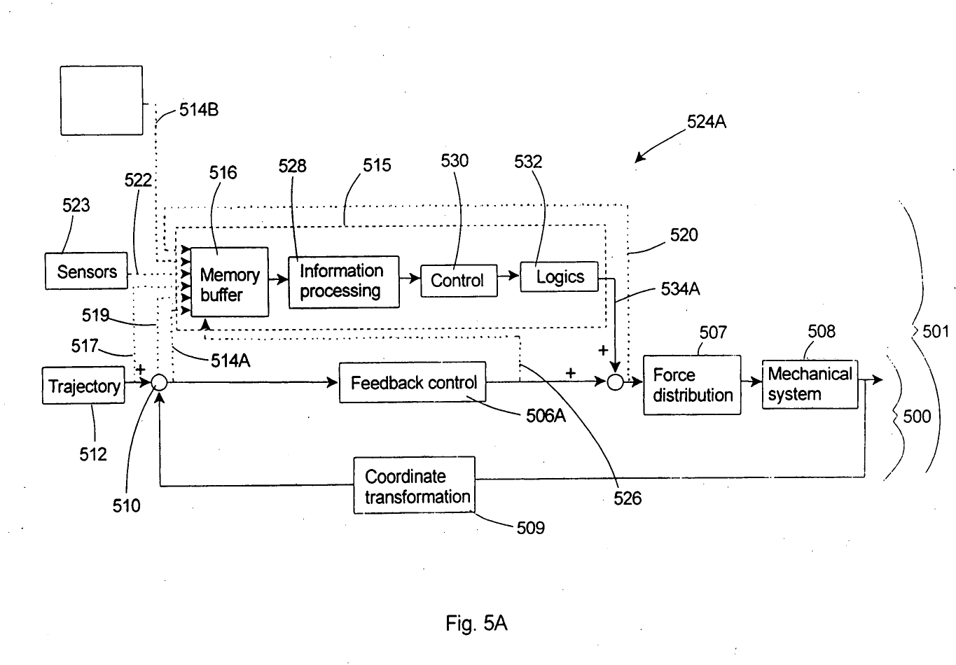

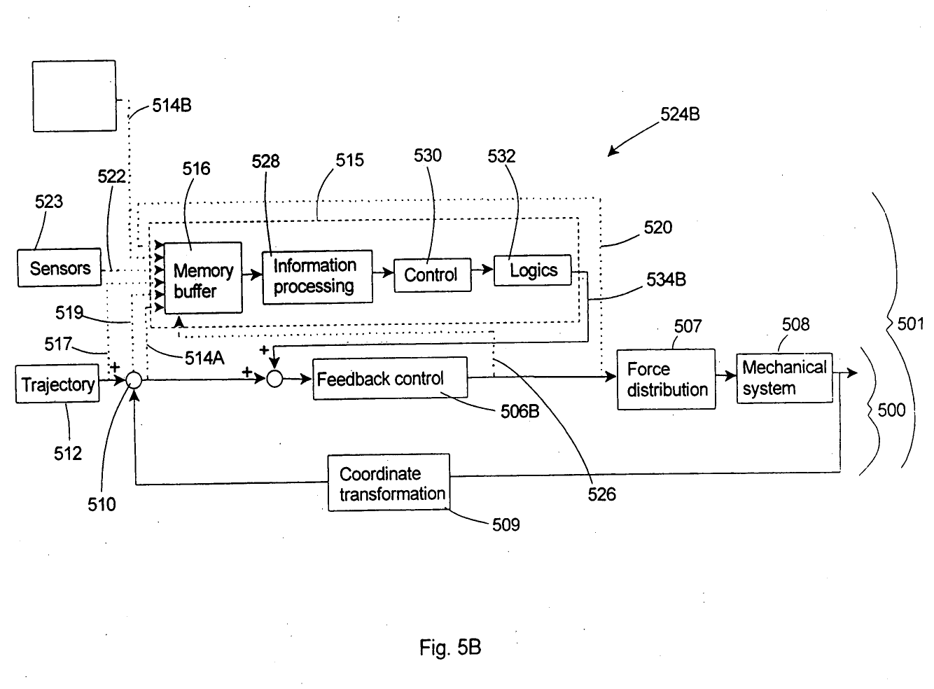

FIGS. 5A-5B illustrate two embodiments of the control system. Not all the steps shown outlined in each embodiment are required to control movement of the stage.

In FIG. 5A, the control system 524A includes the first control mode 500 and the second control mode 501 to control the stage. In the first control mode 500, the control system 524A takes the following error 514A into feedback controller 506A and uses it to improve positioning of the device to be positioned. An intended trajectory 512 of the stage is determined based on the desired path of the device. The intended trajectory 512 can be along the X axis, along the Y axis, and/or about of the Z axis. Additionally, the intended trajectory 512 may also include components about the X axis, about the Y axis, and/or along the Z axis, or any combination thereof.

In one embodiment, during the first control mode 500, one or more points in time along the intended trajectory 512 are compared with points in time from the actual trajectory 510 to determine whether the stage is properly positioned, and to determine whether the stage will be properly positioned in the immediate future. The actual trajectory 510 is determined by the measurement system 22 (FIG. 1) which generates a sensor signal. The measurement system 22 measures the current position of the stage, and thus the object, relative to the assembly 16 (FIG. 1). The sensor signal is then sent to the control system 524A. Each sensor signal provides information relating to the actual position of the stage in one or more degrees of freedom at a specific point in time. The following error 514A for the stage is determined by computing the difference between the intended trajectory 512 and the actual trajectory 510 at a specific point in time. Based on the extent of the following error 514A, a control law 506A determines the extent to which the current to the one or more mover assemblies is adjusted, if at all. The control law 506A may be in the form of a PID (proportional integral derivative) controller, proportional gain controller, or a lead-lag filter, or other commonly known law in the art of control, for example.

Once the control law 506A determines the current to be applied, the current is distributed to the one or more mover assemblies as appropriate (at step 507). The mechanical system, which includes the mover assemblies, then moves the stage at step 508, causing the stage to more accurately emulate the intended trajectory 512 of the stage. The position of the stage is then used to determine the position of the center of gravity (CG) and/or the position of the object using coordinate transformation at step 509. Information regarding the position of the object is then compared with a desired position of the object based on the intended trajectory 512 in order to increase positioning accuracy. The first control mode 500 may continue in this manner until the present iteration has concluded. Upon commencement of a subsequent iteration, new data regarding the following error 514A is continually generated from within the current iteration. This new data regarding the following error 514A is used in a similar manner during the first control mode 500 as described above.

The second control mode 501 of the control system 524A collects and assimilates the learning algorithm input data in order to determine the appropriate amount of current to direct to the mover assemblies to move the stage with increased accuracy. The second control mode 501 can compensate for one or more types of repetitive activities. These repetitive activities can include position-dependent activities such as following errors 514A, and/or periodical, time-dependent disturbances, such as unwanted vibration of portions of the mechanical system. The second control mode 501 may include the first control mode 500, in addition to a position compensation system or module (indicated in dashed box 515) having one or more steps that further increase the accuracy of the positioning and alignment of one or more of the stages. The steps included in the functioning of the position compensation module 515 of the second control mode 501 may vary. The position compensation module 515 may receive and process data from previous iterations to continually decrease the following error 514A and/or offset the effects of any vibration disturbances of the mechanical system in the current and future iterations.

Learning algorithm input data from one or more iterative movements of the stage is collected and provided to a memory buffer 516 for use during future iterations. The learning algorithm input data may include the intended trajectory 512 at various points in time (illustrated by dotted line 517). The learning algorithm input data may include the following error 514A of the stage. The intended trajectory data 517 and the following error data 514A are stored in the memory buffer 516. The learning algorithm input data may also include a compilation of following errors 514A, 514B from two or more stages in the exposure apparatus 10, also known as a synchronization error. The synchronization error is a measurement of how accurately two or more stages are moving relative to each other, compared with the intended trajectory 512 of each of the respective stages. The learning algorithm input data may include the actual position of the stage (illustrated by dotted line 519) at various points in time along the actual trajectory 510 from one or more iterations. The learning algorithm input data may further include information relating to the current directed to the mover assemblies (illustrated by dotted line 520) during previous iterations and/or during the current iteration. The learning algorithm input data may include positioning data. Position-dependent positioning data including sensor information (illustrated by dotted line 522) is also provided to the memory buffer 516. Learning algorithm input data in the form of force command data can be provided to the memory buffer 516 immediately following application of the feedback control step 506A from the first control mode of the control system 524A (illustrated by dotted line 526), i.e., prior to application of the position compensation module 515 to control the current to the one or more mover assemblies. Moreover, because the stage is capable of moving with one or more degrees of freedom, learning algorithm input data for each of the applicable principal axes over one or more iterations can likewise be provided to the memory buffer 516. Once a sufficient amount of learning algorithm input data has been received by the memory buffer 516, this information can be processed (indicated in step 528) by the control system 524A. During information processing 528, useful information can be extracted from the learning algorithm input data that has been collected in the memory buffer 516. Further, the learning algorithm input data can be transformed as necessary into information that can be utilized by the control system 524A to more accurately move and position the stage. The specific process utilized by the control system 524A to process the learning algorithm input data can be varied. Additional details can be found in U.S. Provisional Patent Application No. 60/424,506.

The information processing step 528 can include a periodic evaluation of the performance of the control system 524A to determine whether the parameters of the position compensation module 515 need to continue to be updated. For example, once the following errors 514A converge to below a predetermined threshold level (which can vary), updating of the parameter can be temporarily suspended until the following errors 514A exceed the specified threshold, at which point the parameters can again be updated. With this design, once the following errors 514A have been lowered to below the specified threshold, any high frequency noise or other anomalous data will not contaminate the output of the position compensation module 515.

Following information processing, a control law 530 is calculated by the control system 524A, and the control law 530 is applied to the processed learning algorithm input data. In some embodiments, the control law 530 is a function of both time and vibration disturbance iterations. The control law may be model-based or non-model-based. Additionally, the control system 524A includes logics 532 which allow the position compensation module 515 to be manually turned on or off as necessary. Once the control law 530 has been applied to the processed learning algorithm input data to generate learning data, the position compensation module 515 is then used as a force feedforward to control the current that is directed to the one or more mover assemblies at step 534A. Thus, the current that has been determined as a result of the feedback control 506A of the first control mode 500 is modified by the position compensation module 515 to more accurately position the stage. The system for carrying out the first control mode to control the stage may be referred to the stage control module.

FIG. 5B shows a second embodiment of the control system 524B including the first control mode and the second control mode 501. In general, the functioning of the control system 524B with feedback control 506B in this embodiment is similar to the control system 524A in FIG. 5A. The output of the position compensation module 515 (i.e., the learning data), however, is used as a position feedforward control to fine-adjust the following error 514A for the first control mode 500 of the control system 524B, as indicated by step 534B. The constitution of the control system 524B in this embodiment provides substantially the same effects and results of the control system 524A from the embodiment of FIG. 5A.

In FIG. 5A, the learning algorithm input data from path 526 is referred to as force command data. If the force command data from path 526 is provided to the memory buffer 516 and used in the learning algorithm but the following error data from path 514A is not sent to the memory buffer 516 or not used in the learning algorithm, the control scheme may be referred to as force command iteration learning control or force command ILC. If the following error data from path 514A is sent to the memory buffer 516 but the force command data from path 526 is not sent or not used, the control scheme may be referred to as following error/force command ILC. In FIG. 5B, if the following error data from path 514A is sent to the memory buffer 516 but the force command data from path 526 is not sent or not used, the control scheme may be referred to as following error ILC.

The control scheme as described above extracts information from the previous repetitive (or similar) motion to reduce the stage following error and to remove periodical disturbances. When the control scheme is used to obtain data about the entire range of wafer moving area, it may be referred as the full shot ILC. The controller learns about each step and each scan movement about the entire range of wafer moving area based on a wafer process program, and then uses the result of the learning for controlling the stage. The data is the most suitable value for correction corresponding to the time chart. By obtaining and storing a plurality of learning data that depend on process programs having particular width of pitch and scan motions and scan velocities respectively, the controller may select the learning data according to each process program. This full shot ILC needs long learning time to obtain the data. Furthermore, a large memory size is typically needed to store all the data. Scanning typically occurs by exposure over a plurality of shot in a step and scan process. The shot size of the exposure is specified by the user, and affects the learning process of the ILC approach. If the shot size is changed, the ILC process must be repeated to obtain the control data.

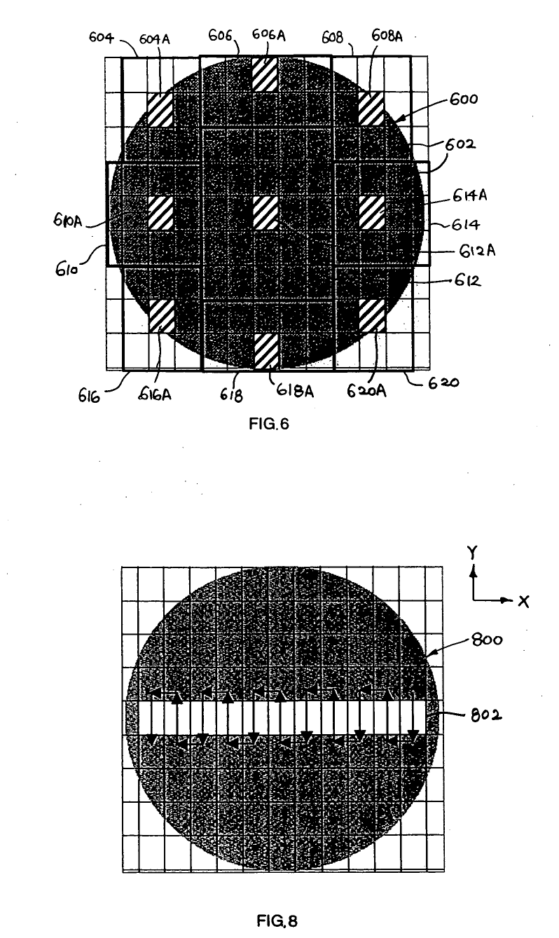

One approach to reduce the learning time is to divide the whole range of wafer moving area into small blocks according to a grouping method. The controller obtains the data of the center area of each block for use as a representative data for the control of that block. The control for the remaining portion of the block is done by using the representative data of the block. FIG. 6 shows an example of a wafer 600 with a grid illustrating the grid elements or units 602 of the moving areas. The wafer 600 is divided into a plurality of blocks 604, 606, 608, 610, 612, 614, 616, 618, 620 having representative center areas 604A-620A. Each block includes one or more of the grid elements 602. Each grid element 602 may also be referred to as a shot in the exposure apparatus. Each grid element 602 may have a size of, e.g., about 25 mm×33 mm.

In some embodiments, the representative data is used directly for the control of the remaining portion of the block. In other embodiments, interpolation and/or extrapolation methods are used for suitable system parameters, such as linear motor phase. That is, representative data obtained for the representative areas may be used to interpolate data between the representative areas and extrapolate data beyond the representative areas. As a result, more continuous and suitable correction for the control of the entire operating range may be created from the representative data sets. FIG. 7 shows an example of an interpolation/extrapolation curve 700 for the learning data or feedforward output (Uₒᵤₜₚᵤₜ) generated by the position compensation module 515 as a function of stage velocity using three representative data 704, 706, 708. FIG. 7 shows a linear function. To move the stage with a certain stage velocity, the feedforward controller may use this interpolated data, instead of the original learning data.

Using the grouping method, the controller can select different block sizes depending on the location on the wafer to improve the accuracy of the data. For example, where the portion of the wafer is positioned near a corner of a stage base, the controller divides the wafer moving area of that portion of the wafer into smaller blocks as compared to another portion of the wafer which is positioned away from the corner of the stage base and closer to the center of the stage base. Near the corner of the stage base, the stage control may be affected by vibration at the corner and less accurate. Near the center of the stage base, the stage control is more accurate and the representative data from the representative area can be used more accurately to control the entire block. The portion of the wafer near the edge may be affected by edge effects, and thus will utilize blocks that are smaller than the blocks near the center. This is seen in FIG. 6 where the corner blocks 604, 608, 616, 620 are smaller than the other blocks, and the center block 612 is larger than the corner blocks and the edge blocks 606,610,614,618.

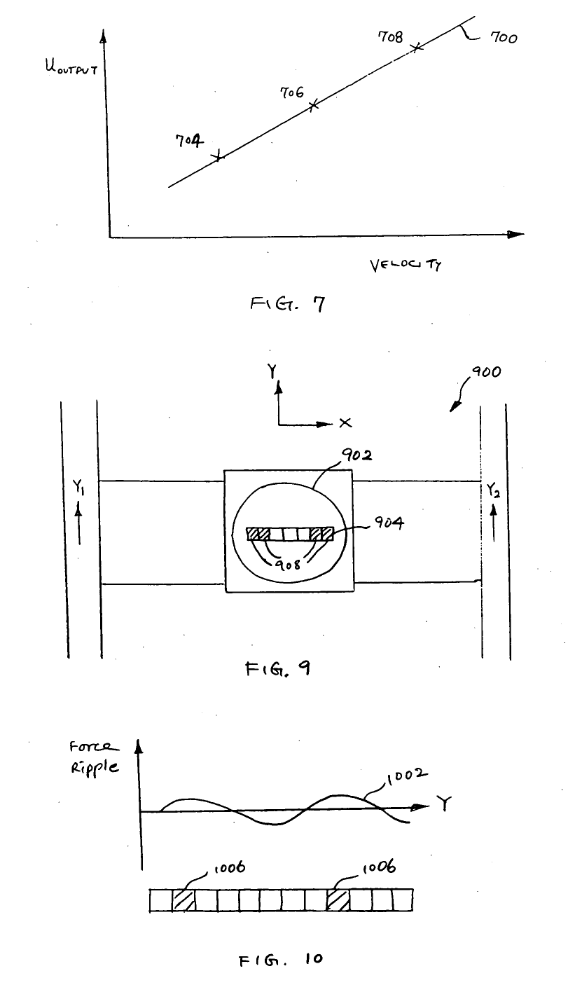

In another grouping scheme, it is recognized that the stage position error during scanning may depend on scanning position. As illustrated in FIG. 8, the grid elements of the moving areas have similar stage position errors along a row 802 of the wafer 800. The row 802 (along the stepping direction X) is oriented transverse to the scanning direction (Y direction), and may be selected as a block. Additionally, the force effect such as force ripple in the Y direction is substantially the same along the row of grid elements oriented along the X direction. The representative data from one shot in the row 802 can be used to control the remaining portion of the block.

Moreover, the block can be selected based on center of gravity (CG) error compensation. Different apparatus have different CG calibration accuracy. As illustrated in FIG. 9, the force applied along the Y₁ track and the force applied along the Y₂ track of the stage 900 to move the wafer 902 in the Y direction may be different to compensate for CG calibration errors. Thus, the block can be selected along a row 904 in the X direction having similar CG calibration errors. It is noted that the block may include discrete grid elements or shots or shot regions along a row, and does not have to be a continuous block including all elements or shots along that row. For example, FIG. 9 shows a block of shaded grid elements 908.

Another criterion for selecting the block is based on the force effects such as force ripple. FIG. 10 shows the effects of force ripple in the scanning direction Y for a linear motor. As illustrated by the curve 1002, the force effects are periodic and similar for each phase. A block having similar force effects may be selected along the Y direction to include shaded grid elements or shot regions 1006 separated by a phase distance. Other examples of force effects include cable drag, change in center of gravity during stage movement, and the like. If it is possible to identify grid elements or shot regions having similar force effects, the force effects can be used as one criterion for selecting elements for the block.

FIG. 11 is a flow diagram illustrating a learning control method incorporating a grouping scheme according to an embodiment of the present invention. In step 1102, the wafer is divided into blocks according to one or more criteria such as those described herein. Each block includes one or more shot regions or grid elements. In step 1104, learning data is generated for one or more representative shot regions for each block. In step 1106, the learning data is used to control the stage for the shot regions of the entire block.

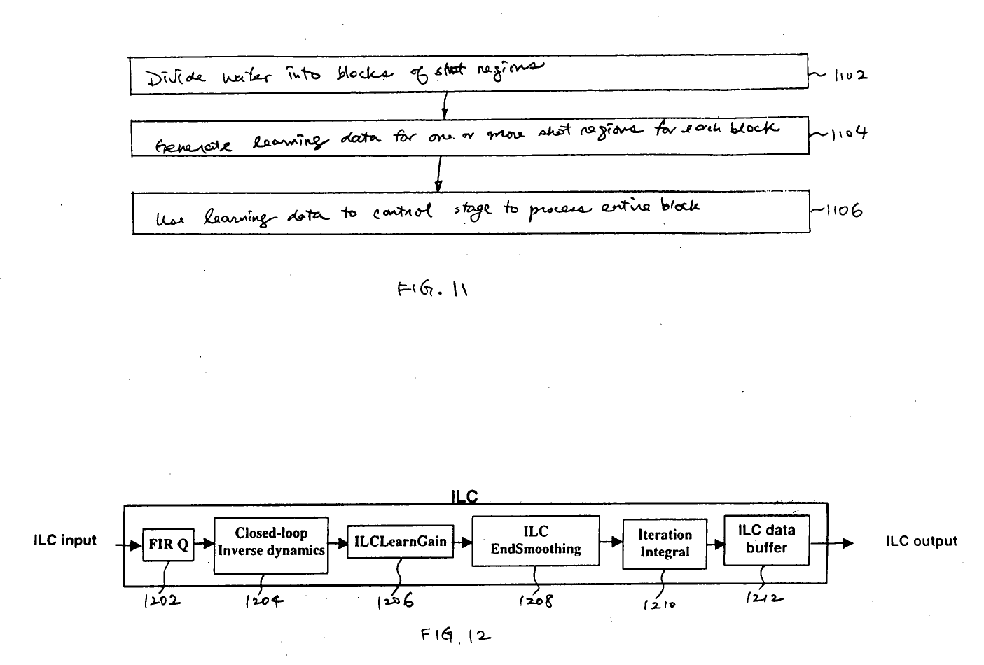

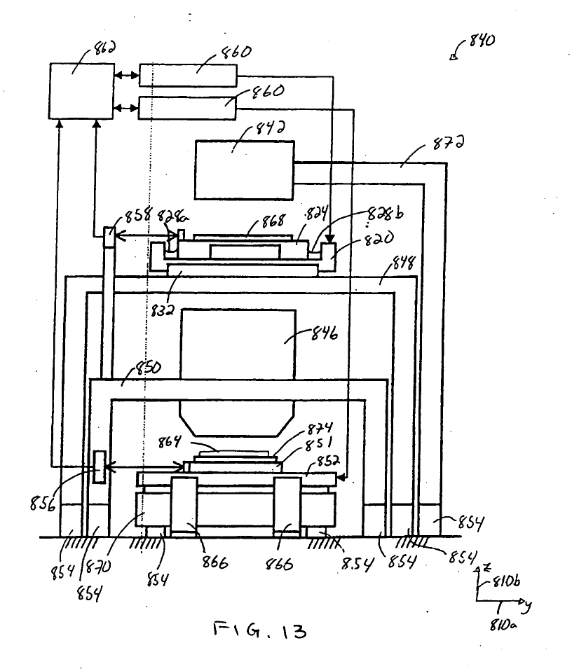

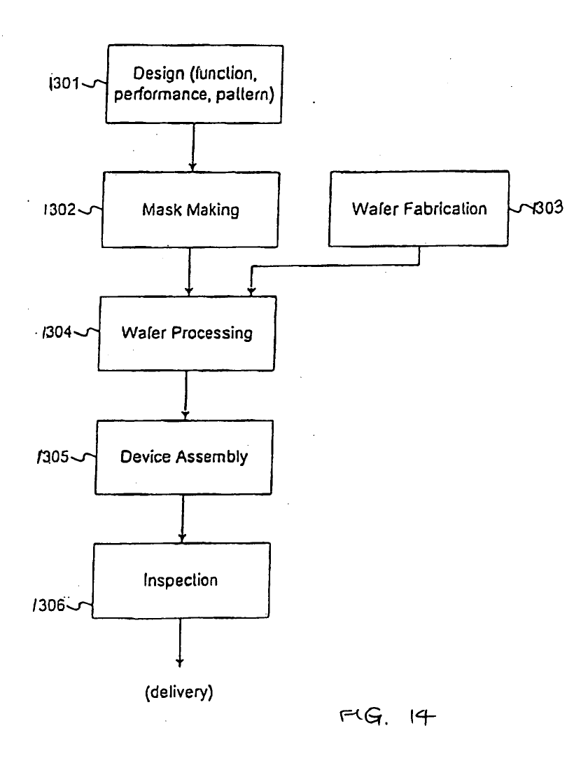

The learning data may be generated using the position compensation scheme 515 shown in FIG. 5A or FIG. 5B. FIG. 12 is a flow diagram illustrating an iterative learning control method which may be implemented according to an embodiment of the invention. The learning algorithm data stored in the memory buffer 516 is used as the ILC input to be processed by the information processing module 528. In FIG. 12, information processing involves filtering the ILC data by a finite impulse response filter (FIR Q) 1202 and processing the filtered data by a closed-loop inverse dynamics module 1204. To apply the control law 530 to the processed data in the embodiment shown in FIG. 12, the data is subjected to an ILC learning gain 1206, an ILC end smoothing 1208, and an iteration integral 1210. The learning data that is generated can be stored in an ILC data buffer 1212 and used as the ILC output. Of course, other iterative learning control schemes may be employed. The method described herein may be implemented in software or firmware to be carried out by the control system 24 having a processor, one or more memories, input, and output.

An overall reticle scanning stage device with dual force mode capabilities may be used as a part of a photolithography apparatus. With reference to FIG. 13, a photolithography apparatus which includes an overall reticle scanning stage device with dual force mode capabilities will be described in accordance with an embodiment of the present invention. A photolithography apparatus (exposure apparatus) 840 includes a wafer positioning stage 852 that may be driven by a planar motor (not shown), as well as a wafer table 851 that is magnetically coupled to wafer positioning stage 852. It should be appreciated that, in one embodiment, wafer positioning stage 852 may include a wafer coarse stage and a wafer fine stage which include dual force mode capabilities similar to those described above for a reticle scanning stage.

The planar motor which drives wafer positioning stage 852 generally uses an electromagnetic force generated by magnets and corresponding armature coils arranged in two dimensions. A wafer 864 is held in place on a wafer holder 874 which is coupled to wafer table 851. Wafer positioning stage 852 is arranged to move in multiple degrees of freedom, e.g., between three to six degrees of freedom, under the control of a control unit 860 and a system controller 862. The movement of wafer positioning stage 852 allows wafer 864 to be positioned at a desired position and orientation relative to a projection optical system 846.

Wafer table 851 may be levitated in a z-direction 810b by any number of voice coil motors (not shown), e.g., three voice coil motors. In the described embodiment, at least three magnetic bearings (not shown) couple and move wafer table 851 along a y-axis 810a. The motor array of wafer positioning stage 852 is typically supported by a base 870. Base 870 is supported to a ground via isolators 854. Reaction forces generated by motion of wafer positioning stage 852 may be mechanically released to a ground surface through a frame 866. One suitable frame 866 is described in JP Hei 8-166475 and U.S. Pat. No. 5,528,118, which are each herein incorporated by reference in their entireties.

An illumination system 842 is supported by a frame 872. Frame 872 is supported to a ground via isolators 854. Illumination system 842 includes an illumination source, and is arranged to project a radiant energy, e.g., light, through a mask pattern on a reticle 868 that is supported by and scanned using a reticle stage which includes a coarse stage 820 and a fine stage 824. The radiant energy is focused through projection optical system 846, which is supported on a projection optics frame 850 and may be released to the ground through isolators 854. Coarse stage 820 and fine stage 824 are connected by cords 828 which enable fine stage 824 to accelerate with coarse stage 820 in y-direction 810a, as described above. Specifically, when a linear motor 832 causes coarse stage 820 to accelerate in y-direction 810a, one of cords 828 is pulled into tension by the acceleration of coarse stage 820 to cause fine stage 824 to accelerate. For instance, when acceleration is in a positive y-direction 810a, then cord 828b may be pulled into tension. Alternatively, when acceleration is in a negative y-direction 810a, then cord 828a may be pulled into tension. A stator of linear motor 832 is connected to a reticle stage frame 848, therefore reaction forces generated by motion of coarse stage 820 and fine stage 824 may be mechanically released to a ground surface through isolators 854. Suitable isolators 854 include those described in JP Hei 8-330224 and U.S. Pat. No. 5,874,820, which are each incorporated herein by reference in their entireties.

A first interferometer 856 is supported on projection optics frame 850, and functions to detect the position of wafer table 851. Interferometer 856 outputs information on the position of wafer table 851 to system controller 862. A second interferometer 858 is supported on projection optics frame 850, and detects the position of coarse stage 820 and, in one embodiment, fine stage 824. Interferometer 858 also outputs position information to system controller 862.

It should be appreciated that there are a number of different types of photolithographic apparatuses or devices. For example, photolithography apparatus 840, or an exposure apparatus, may be used as a scanning type photolithography system which exposes the pattern from reticle 868 onto wafer 864 with reticle 868 and wafer 864 moving substantially synchronously. In a scanning type lithographic device, reticle 868 is moved perpendicularly with respect to an optical axis of a lens assembly (projection optical system 846) or illumination system 842 by coarse stage 820 and fine stage 824. Wafer 864 is moved perpendicularly to the optical axis of projection optical system 846 by a positioning stage 852. Scanning of reticle 868 and wafer 864 generally occurs while reticle 868 and wafer 864 are moving substantially synchronously.

Alternatively, photolithography apparatus or exposure apparatus 840 may be a step-and-repeat type photolithography system that exposes reticle 868 while reticle 868 and wafer 864 are stationary, e.g., when neither a fine stage 820 nor a coarse stage 824 is moving. In one step and repeat process, wafer 864 is in a substantially constant position relative to reticle 868 and projection optical system 846 during the exposure of an individual field. Subsequently, between consecutive exposure steps, wafer 864 is consecutively moved by wafer positioning stage 852 perpendicularly to the optical axis of projection optical system 846 and reticle 868 for exposure. Following this process, the images on reticle 868 may be sequentially exposed onto the fields of wafer 864 so that the next field of semiconductor wafer 864 is brought into position relative to illumination system 842, reticle 868, and projection optical system 846.

It should be understood that the use of photolithography apparatus or exposure apparatus 840, as described above, is not limited to being used in a photolithography system for semiconductor manufacturing. For example, photolithography apparatus 840 may be used as a part of a liquid crystal display (LCD) photolithography system that exposes an LCD device pattern onto a rectangular glass plate or a photolithography system for manufacturing a thin film magnetic head. Further, the present invention may also be applied to a proximity photolithography system that exposes a mask pattern by closely locating a mask and a substrate without the use of a lens assembly. Additionally, the present invention provided herein may be used in other devices including, but not limited to, other semiconductor processing equipment, machine tools, metal cutting machines, and inspection machines.

The illumination source of illumination system 842 may be g-line (436 nanometers (nm)), i-line (365 nm), a KrF excimer laser (248 nm), a ArF excimer laser (193 nm), and an F.sub.2-type laser (157 nm). Alternatively, illumination system 842 may also use charged particle beams such as x-ray and electron beams. For instance, in the case where an electron beam is used, thermionic emission type lanthanum hexaboride (LaB.sub.6) or tantalum (Ta) may be used as an electron gun. Furthermore, in the case where an electron beam is used, the structure may be such that either a mask is used or a pattern may be directly formed on a substrate without the use of a mask.

With respect to projection optical system 846, when far ultra-violet rays such as an excimer laser is used, glass materials such as quartz and fluorite that transmit far ultraviolet rays is preferably used. When either an F.sub.2-type laser or an x-ray is used, projection optical system 846 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

Further, in photolithography systems, when linear motors (see U.S. Pat. Nos. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

As described above, a photolithography system according to the above-described embodiments may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

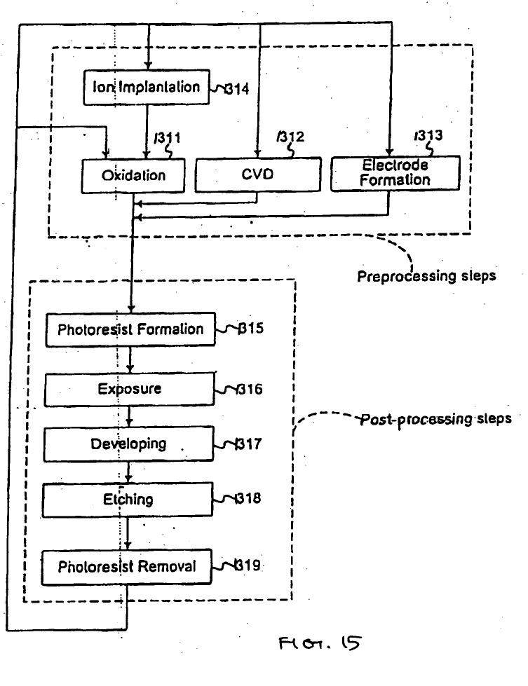

Further, semiconductor devices may be fabricated using systems described above, as will be discussed with reference to FIG. 14. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system that includes a coarse reticle scanning stage and a fine reticle scanning stage that accelerates with the coarse reticle scanning stage as described above. One process of exposing a mask pattern onto a wafer will be described below with respect to FIG. 15. In step 1305, the semiconductor device is assembled. The assembly of the semiconductor device generally includes, but is not limited to, wafer dicing processes, bonding processes, and packaging processes. Finally, the completed device is inspected in step 1306.

FIG. 15 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage. In one embodiment, scanning the reticle scanning stage includes accelerating a fine stage with a coarse stage using a cord, then accelerating the fine stage substantially independently from the coarse stage.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

While cords are suitable for providing an overall reticle scanning stage device with dual force mode capabilities, it should be appreciated that cords are just one example of a “variable coupler,” i.e., a coupler between a coarse stage and a fine stage that may alternately be characterized by allowing high transmissibility between the stages and allowing relatively low transmissibility between the stages. Other suitable couplers include, but are not limited to, opposing motors which are coupled to substantially stationary amplifiers, and stops.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

1. A method of controlling movement of one or more stages of a precision assembly to process a substrate having a plurality of process regions, the method comprising:
dividing the substrate into blocks according to one or more preset criteria, each block of the substrate including one or more process regions;
generating learning data for one or more representative process regions for each block of the substrate; and
using the generated learning data of the one or more representative process regions of each block to control movement of the one or more stages to process the block of one or more process regions of the substrate.

2. The method of claim 1 wherein the blocks comprise at least one center block in a center region of the substrate and at least one edge block in an edge region of the substrate.

3. The method of claim 2 wherein each center block is larger in area than each edge block.

4. The method of claim 1 wherein the blocks comprise a block having a row of process regions along a stepping direction and transverse to a scanning direction for a step-and-scan processing of the substrate.

5. The method of claim 1 wherein the blocks comprise a block having a plurality of process regions selected from a row of process regions along a stepping direction and transverse to a scanning direction for a step-and-scan processing of the substrate.

6. The method of claim 1 wherein dividing the substrate into blocks comprises selecting process regions having substantially the same force effects and grouping the selected process regions into a block.

7. The method of claim 1 wherein dividing the substrate into blocks comprises selecting process regions having substantially the same stage position errors and grouping the selected process regions into a block.

8. The method of claim 1 wherein dividing the substrate into blocks comprises selecting process regions having substantially the same center of gravity calibration errors and grouping the selected process regions into a block.

9. The method of claim 1 wherein the blocks comprise a block having process regions which are spaced from each other by other process regions.

10. The method of claim 1 wherein generating learning data comprises performing an iterative learning control process on iterative learning control input data which is selected from the group consisting of a following error of the one or more stages and a force command of the one or more stages.

11. The method of claim 1 wherein generating learning data comprises generating a force feedforward to be applied to the one or more stages.

12. The method of claim 11 wherein generating learning data comprises performing a control process on learning control input data which is selected from the group consisting of a following error of the one or more stages and a force command of the one or more stages.

13. The method of claim 1 wherein generating learning data comprises generating a position feedforward control to fine-adjust a following error of the one or more stages which is processed by a feedback control to control movement of the one or more stages.

14. The method of claim 13 wherein generating learning data comprises performing a control process on learning control input data which comprises a following error of the one or more stages.

15. The method of claim 1 further comprising performing at least one of interpolating or extrapolating the learning data generated for the representative process regions to generate additional learning data for other process regions; and using the additional learning data to control movement of the one or more stages to process the other process regions of the substrate.

16. A system of controlling movement of one or more stages of a precision assembly to process a substrate having a plurality of process regions, the system comprising:
a position compensation module configured to generate learning data for one or more representative process regions for each block of a plurality of blocks of a substrate, each block including one or more process regions; and
a stage control module configured to use the generated learning data of the one or more representative process regions of each block to control movement of the one or more stages to process the block of one or more process regions of the substrate.

17. The system of claim 16 wherein the position compensation module is configured to perform an iterative learning control process on iterative learning control input data which is selected from the group consisting of a following error of the one or more stages and a force command of the one or more stages.

18. The system of claim 16 wherein the position compensation module is configured to generate a force feedforward to be applied to the one or more stages.

19. The system of claim 16 wherein the position compensation module is configured to generate a position feedforward control to fine-adjust a following error of the one or more stages which is processed by a feedback control to control movement of the one or more stages.

20. The system of claim 16 wherein the position compensation module is configured to perform at least one of interpolating or extrapolating the learning data generated for the representative process regions to generate additional learning data for other process regions; and use the additional learning data to control movement of the one or more stages to process the other process regions of the substrate.

21. A system for controlling movement of one or more stages of a precision assembly to process a substrate having a plurality of process regions, the system having one or more memories, the one or more memories comprising:
code for generating learning data for one or more representative process regions for each block of a plurality of blocks of a substrate, each block including one or more process regions; and
code for using the generated learning data of the one or more representative process regions of each block to control movement of the one or more stages to process the block of one or more process regions of the substrate.

22. The system of claim 21 wherein the code for generating learning data comprises code for performing an iterative learning control process on iterative learning control input data which is selected from the group consisting of a following error of the one or more stages and a force command of the one or more stages.

23. The system of claim 21 wherein the code for generating learning data comprises code for generating a force feedforward to be applied to the one or more stages.

24. The system of claim 21 wherein the code for generating learning data comprises code for generating a position feedforward control to fine-adjust a following error of the one or more stages which is processed by a feedback control to control movement of the one or more stages.

25. The system of claim 21 wherein the code for generating learning data comprises code for performing at least one of interpolating or extrapolating the learning data generated for the representative process regions to generate additional learning data for other process regions; and using the additional learning data to control movement of the one or more stages to process the other process regions of the substrate.

26. A method of operating an exposure apparatus comprising:
reciting a substrate with a stage;
controlling movement of the stage utilizing the method of claim 1; and
exposing the substrate with radiant energy.

27. A method for making a micro-device including at least the photolithography process, wherein the photolithography process utilizes the method of operating an exposure apparatus of claim 26.

28. A method for making a wafer utilizing the method of operating an exposure apparatus of claim 26.

29. A stage device comprising:
a stage that retains an object; and
the system of claim 16;
wherein the system is configured to control the movement of the stage that retains the object.

30. An exposure apparatus comprising:
an illumination system that irradiates radiant energy; and
the stage device according to claim 29, the stage device carrying the object disposed on a path of the radiant energy.
